(19) United States
(12) Patent Application Publication
(10) Pub. No.: US 2008/0127848 A1
(43) Pub. Date: Jun. 5, 2008

(54) Methods and apparatuses for making lithographic plates

(76) Inventor: Robert M. Deis, Hudson, WI (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 11/731,020

(22) Filed: Mar. 28, 2007

Related U.S. Application Data
(60) Provisional application No. 60/786,848, filed on Mar. 28, 2006.

(51) Int. Cl. B41M 5/00; B41F 27/00

(52) U.S. Cl. 101/463.1; 101/382.1

(57) ABSTRACT

Alignment systems and methods of alignment for use with lithographic printing plate processing machines are provided. An alignment system in accordance with the present invention includes one or more movable cam surfaces, one or more loading devices, one or more imaging devices, and a control system. The one or more cam surfaces are configured to engage an edge of a printing plate positioned in the alignment system and controllably translate the printing plate to align the printing plate with the alignment system. The one or more loading devices are configured to positively engage an edge of the printing plate against the one or more movable cam surfaces. The one or more imaging devices are configured to view an alignment mark on the printing plate positioned in the alignment system. The control system controls movement of the cam surfaces in response to information comprising the position of an alignment mark as viewed by the one or more imaging devices.

### PRIORITY CLAIM

This application claims the benefit of U.S. Provisional Patent Application having Ser. No. 60/786,848 filed on Mar. 28, 2006, entitled “Methods and Apparatuses for Making Lithographic Plates,” the entire disclosure of which is incorporated herein by reference for all purposes.

### TECHNICAL FIELD

The present invention relates generally to the processing of lithographic plates. More particularly, the present invention relates to alignment systems and methods for use with equipment for bending and/or punching lithographic plates for the purpose of mounting and securing such plates on a press plate cylinder.

### BACKGROUND

A typical lithographic plate includes features such as flanges and openings that enable it to be mounted on a printing plate cylinder of a printing press. The configuration of these flanges and openings defines the alignment between plural plates installed on a printing press and provides the registration of the printed image. Accordingly, precision metal working techniques for bending such flanges and forming such openings are used to ensure precision alignment between plural plates mounted on a printing press.

A typical machine used for forming a precision bend in a lithographic plate includes an anvil provided at the end of a supporting surface, a clamping device for clamping a plate to be bent to the supporting surface, and a mandrel for bending the plate around the anvil to form a flange. The anvil has an end with a forming surface that has a predetermined radius and a bend is made by rolling the plate around the radius of the forming surface of the anvil. In this way, the material of the plate conforms to the shape of the anvil to form a bend radius in the flange that is defined by the radius of the forming surface of the anvil. Machine tools for bending lithographic plates are described in U.S. Pat. No. Re. 31,938, reissued Jul. 9, 1985, to Klukow, U.S. Pat. No. 5,970,774 to Burgess et al., and U.S. Pat. No. 5,454,247 to Powers et al., the disclosures of which are incorporated herein by reference in their entirety for all purposes.

Usually, such flanges are formed after an image is provided on the printing plate. Because a flange defines the position of a printing plate with respect to the printing machine, the flange also controls the position of the image with respect to the printing machine. Accordingly, such flanges are desirably aligned to the image on the printing plate.

### SUMMARY

In one aspect of the present invention, an alignment system for use with a lithographic printing plate processing machine is provided. The alignment system preferably comprises one or more movable cam surfaces, one or more loading devices, one or more imaging devices, and a control system. The one or more cam surfaces are configured to engage an edge of a printing plate positioned in the alignment system and controllably translate the printing plate to align the printing plate with the alignment system. The one or more loading devices are configured to positively engage an edge of the printing plate against the one or more movable cam surfaces. The one or more imaging devices are configured to view an alignment mark on the printing plate positioned in the alignment system. The control system controls movement of the cam surfaces in response to information comprising the position of an alignment mark as viewed by the one or more imaging devices.

In another aspect of the present invention, a method of processing a lithographic printing plate is provided. The method preferably comprising the steps of positioning a printing plate in an alignment system of a lithographic printing plate processing machine, positively engaging an edge of the printing plate against a moveable cam surface, viewing at least one alignment mark provided on the printing plate to determine the position of the at least one alignment mark relative to the alignment system, and controllably moving the cam surface to move the alignment mark relative to the alignment system.

### BRIEF DESCRIPTION OF THE DRAWINGS

FIG. 1 is a schematic view of an alignment system in accordance with the present invention that can be used for processing lithographic plates and showing in particular plural controllable cam surfaces and opposing loading devices that can cooperate to align a lithographic plate by using alignment marks on the lithographic plate and viewing devices of the alignment system; and

FIG. 2 is a schematic view of the alignment system of FIG. 1 showing the printing plate in an aligned position where alignment marks of the printing plate are aligned with viewing devices of the alignment system.

### DETAILED DESCRIPTION

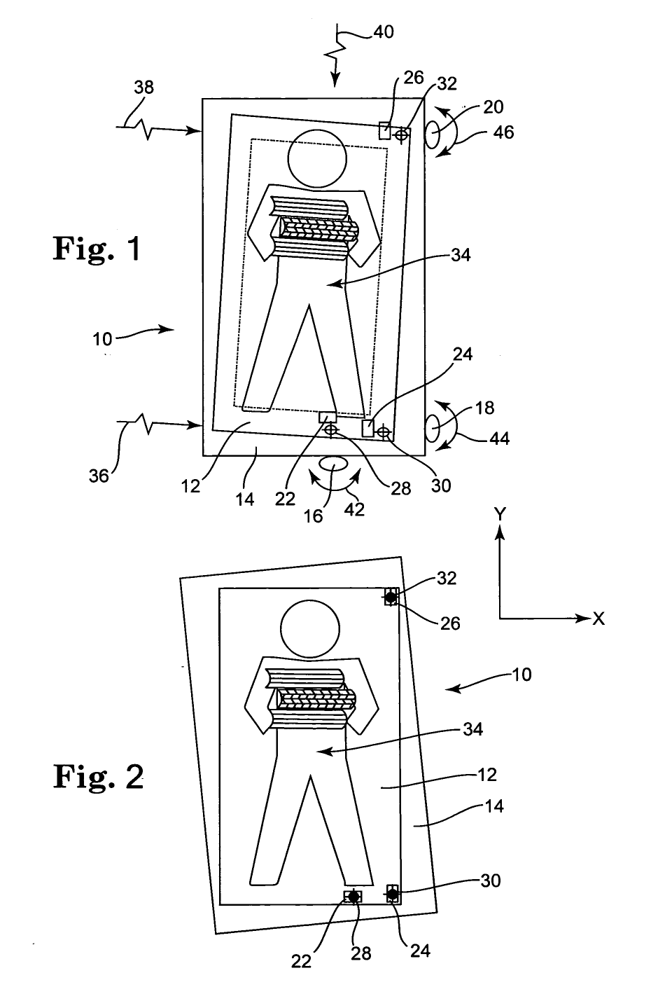

FIG. 1 schematically shows an alignment system 10 in accordance with the present invention for aligning a printing plate 12 with respect to a processing machine, such as a bending, punching, and/or imaging machine (not shown). The alignment system 10 generally includes a support surface 14 for holding the printing plate 12 (typically provided as a functional part of the processing machine), motor controlled cam surfaces 16, 18, and 20 for adjusting the position of the printing plate 12, imaging devices 22, 24, and 26 for viewing alignment marks 28, 30, and 32 (or features) on the printing plate 12, and a control system for controlling and/or automating the alignment system (not shown).

The printing plate support surface 14 preferably comprises a structural element that can hold the printing plate 12 with respect to the processing machine such as a vacuum table or the like that is preferably functionally integrated with the processing machine. For example, the support surface 14 may be a surface of a flange bending machine and the alignment system of the present invention can be used to align a printing plate, with or without an image thereon, to the bending machine for forming a flange aligned to an aspect or feature of the plate and/or image. Machine tools for bending lithographic plates are described in U.S. Pat. No. Re. 31,938, reissued Jul. 9, 1985, to Klukow, U.S. Pat. No. 5,970,774 to Burgess et al., and U.S. Pat. No. 5,454,247 to Powers et al., the disclosures of which are incorporated herein by reference in their entirety for all purposes.

The illustrated printing plate 12 is exemplary and, as shown, comprises an image 34 (not required), and alignment marks 28, 30, and 32, that are registered with a desired aspect or feature of the printing plate such as an image (if present), an edge, flange, hole, or slot of the plate, for example. The alignment marks 28, 30, and 32 may comprise any mark, symbol, indicator, fiducial, or the like that can be used to register the printing plate or image thereon with respect to alignment system 10 and/or a processing machine.

The motor controlled cam surfaces 16, 18, and 20, function to adjust the alignment of the printing plate 12 with respect to the processing machine by moving the printing plate in one or more of the x and y axes. The cam surfaces 28, 30, and 32 are illustrated schematically as elliptical cams but can be provided as surfaces of eccentric bearings, cams, wedges, ramps, or the like. Any surface that can contact a portion of the printing plate, such as an edge or the like, and be controllably moved (rotationally or linearly, for example) to cause a corresponding movement of the printing plate 12 can be used. For example, cams or eccentric bearings rotationally movable by a motor or the like (stepper, servo, and/or indexing motors, for example), preferably under the control of the control system, can be used. As another example, a bearing or surface of a linearly extendable or pivotable arm can be used to contact an edge of the printing plate 12 and controllable move the printing plate 12 in accordance with the present invention.

The alignment system 10 preferably includes at least one cam surface that can move or translate the printing plate 12 in the x direction and at least one cam surface that can move or translate the printing plate 12 in the y direction. As shown, the exemplary alignment system 10 uses cam surfaces 18 and 20 to move the printing plate 12 in the x direction and cam surface 16 to move the printing plate 12 in the y direction. Any number of cam surfaces or devices can be used depending on factors such as plate size, magnitude of translational movement desired, direction of translational movement desired, and the like. Also, the alignment system 10 preferably includes loading devices 36, 38, and 40, that function to positively locate the printing plate 12 against the cam surfaces 16, 18, and 20. Preferably, the loading devices 36, 38, and 40 provide a two-way force (like the force provided by a spring) that loads the printing plate 12 against the cam surfaces 16, 18, and 20. Such two-way force can be provided by springs, cylinders, or other devices that can provide an elastic or two-way force. Such loading forces can be applied in any manner that provides a positive loading of an edge of the printing plate 12 against a cam surface. Preferably, one or more loading forces are provided to an edge of the printing plate 10 opposite an edge engaged with one or more cam surfaces. Such loading sources can be applied at a point or region and can also be provided over a predetermined area, zone, or region. The magnitude of the loading forces is preferably large enough to maintain contact of the printing plate 12 with the cam surfaces 16, 18, and 20 but not so large that the cam surfaces cannot translate the printing plate 12 in accordance with the present invention.

The alignment system 10 also preferably includes imaging devices 22, 24, and 26 or the like that function to view the alignment marks 28, 30, and 32 of the printing plate 12 to determine alignment of the printing plate 12 as controllably positioned by the cam surfaces 16, 18, and 20. Preferably imaging devices 22, 24, and 26 are used to view one or more zones or regions of the support surface 14 that corresponds with a desired alignment of a printing plate when the printing plate is positioned on the support surface 14. That is, the imaging devices 22, 24, and 26 preferably provide an indication of where a corresponding alignment mark on the printing plate 12 is in an aligned position. To provide such indication an imaging device may display or otherwise use an alignment feature together with an alignment feature of the printing plate 12 to verify or indicate an alignment position.

In use, the printing plate 12 is conveyed into the alignment system 10 and docked against the cam surfaces 16, 18, and 20, which preferably function as prealignment stops. The loading devices 36, 38, and 40 are preferably engaged to provide a loading force that positively positions the printing plate 12 against the cam surfaces 16, 18, and 20. When the printing plate 12 is in its initial position as shown in FIG. 1, the alignment marks 28, 30, and 32 of the printing plate 12 are typically spaced apart from their respective predetermined aligned positions. That is, the printing plate 12 is typically initially out of alignment when fed into the alignment system 10 and the printing plate 12 can be brought into alignment as viewed by the imaging devices 22, 24, an 26 and alignment can thus be verified. To align the printing plate 12, the cam surfaces 16, 18, and 20 are controllably moved in rotational directions identified by reference numerals 42, 44 and 46, to cause the printing plate 12 to move along the x and y axes, independently or simultaneously, as needed to position the alignment marks 28, 30, and 32 of the printing plate 12 in an aligned position relative to the imaging devices 22, 24, and 26. This process can be performed manually, such as observed by an operator, or may be performed in an automated manner such by using optical recognition techniques that can identify an alignment mark or that use intensity of a light signal or the like to determine the position of the printing plate 12 relative to the imaging devices 22, 24, and 26.

In FIG. 2, the printing plate 12 is illustrated in an aligned or registered position for the processing machine to perform its operation such as punching and/or bending, or the like. As shown, the alignment marks 28, 30, and 32 of the printing plate 10 are aligned with the imaging devices 22, 24, and 26 indicating that the printing plate 10 is aligned to the alignment system 10 and/or processing machine (not shown).

The present invention has now been described with reference to several embodiments thereof. The entire disclosure of any patent or patent application identified herein is hereby incorporated by reference. The foregoing detailed description and examples have been given for clarity of understanding only. No unnecessary limitations are to be understood therefrom. It will be apparent to those skilled in the art that many changes can be made in the embodiments described without departing from the scope of the invention. Thus, the scope of the present invention should not be limited to the structures described herein, but only by the structures described by the language of the claims and the equivalents of those structures.

What is claimed is:

1. An alignment system for use with a lithographic printing plate processing machine, the alignment system comprising:
one or more movable cam surfaces operatively positionable to engage an edge of a printing plate positioned in the alignment system and controllably translate the printing plate to align the printing plate with the alignment system;
one or more loading devices for positively engaging the edge of the printing plate against the one or more movable cam surfaces;
one or more imaging devices that can view an alignment mark on the printing plate positioned in the alignment system; and
a control system for controlling movement of the cam surfaces in response to information comprising the position of an alignment mark as viewed by the one or more imaging devices.

2. The system of claim 1, wherein the one or more movable cam surfaces comprises an eccentric bearing.

3. The system of claim 1, wherein the one or more loading devices comprises a spring.

4. The system of claim 1, wherein the one or more viewing devices comprises a camera.

5. The system of claim 1 in combination with a lithographic printing plate processing machine.

6. A method of processing a lithographic printing plate, the method comprising the steps of:
positioning a printing plate in an alignment system of a lithographic printing plate processing machine;
positively engaging an edge of the printing plate against a moveable cam surface;
viewing at least one alignment mark provided on the printing plate to determine the position of the at least one alignment mark relative to the alignment system; and
controllably moving the cam surface to move the alignment mark relative to the alignment system.

7. The method of claim 6, further comprising positively engaging a second edge of the printing plate against a second moveable cam surface.

8. The method of claim 6, wherein the step of positively engaging an edge of the printing plate against a moveable cam surface comprises spring loading the edge of the printing plate against the moveable cam surface.

9. The method of claim 6, wherein the step of viewing the at least one alignment mark further comprises comparing the position of the at least one alignment mark to a reference mark indicative of a desired position for the at least one alignment mark.

10. The method of claim 6, comprising aligning the printing plate to the alignment system.

11. A method of processing a lithographic plate, the method comprising the steps of:
providing the alignment system of claim 1;
positioning a printing plate in the alignment system;
positively engaging an edge of the printing plate against the one or more moveable cam surfaces;
viewing at least one alignment mark provided on the printing plate to determine the position of the at least one alignment mark relative to the alignment system; and
controllably moving the cam surface to move the alignment mark relative to the alignment system.

12. The method of claim 11, further comprising positively engaging a second edge of the printing plate against a second moveable cam surface.

13. The method of claim 11, wherein the step of positively engaging an edge of the printing plate against a moveable cam surface comprises spring loading the edge of the printing plate against the moveable cam surface.

14. The method of claim 11, wherein the step of viewing the at least one alignment mark further comprises comparing the position of the at least one alignment mark to a reference mark indicative of a desired position for the at least one alignment mark.
